(19) United States
(12) Patent Application Publication
(10) Pub. No.: US 2024/0391650 A1
(43) Pub. Date: Nov. 28, 2024

(54) LIQUID CONTAINER AND LIQUID REPLENISHMENT SYSTEM

(71) Applicant: CANON KABUSHIKI KAISHA, Tokyo (JP)

(72) Inventors: YOSHITO FUSE, Kanagawa (JP); YUSHI KITASE, Tokyo (JP); RYOJI INOUE, Kanagawa (JP); MANABU OHARA, Tokyo (JP); NORIYASU NAGAI, Tokyo (JP)

(21) Appl. No.: 18/668,735

(22) Filed: May 20, 2024

(30) Foreign Application Priority Data
May 23, 2023 (JP) 2023-084307

(51) Int. Cl. B65D 43/02; B41J 2/175

(52) U.S. Cl. CPC B65D 43/0202; B41J 2/17509; B41J 2/17553; B65D 2543/00259

(57) ABSTRACT

A cover member configured to be removable from a liquid container. The cover member includes a resin having a haze value of 14% or more and 96% or less. A thickness of a top surface of the cover member is 3.0 mm or less. A maximum height roughness Rz of the top surface of the cover member is 50 μm or less. When a back surface of the top surface of the cover member is defined as a first surface and a surface of the protection portion facing the first surface is defined as a second surface, an L′ value of the second surface in Commission Internationale de l'Eclairage (CIE) L′a*b*color space is 5 or more and 35 or less. A shortest distance between the first surface and the second surface is 0.4 mm or more and 2.0 mm or less.

### BACKGROUND

### Field

The present disclosure relates to a liquid container and a liquid replenishment system.

### Description of the Related Art

There is known a liquid container that can replenish a liquid tank for containing liquid therein with the liquid. The liquid is used by a liquid discharge apparatus (image recording apparatus), such as an ink jet recording apparatus, including a liquid discharge head. For example, the liquid container includes an outlet port through which the liquid is injected into the liquid tank. The liquid tank inside the liquid discharge apparatus includes a needle that extends and has a flow path through which the inside and the outside communicate, and the liquid tank can be replenished with the liquid by inserting the needle thereof into the outlet port of the liquid container. In this type of liquid container, as discussed in Japanese Patent Application Laid-Open No. 2017-222152, to prevent user's hands and objects around the user from becoming dirty, a valve having a slit is arranged at a leading end of the outlet port to prevent liquid leakage. The valve is opened by the needle inserted into the outlet port of the liquid container, and the liquid tank is replenished with the liquid.

Japanese Patent Application Laid-Open No. 2017-222152 further discusses that when the liquid is injected from the liquid container to the liquid tank, since the valve is opened in a state of being positioned with respect to the liquid tank, troubles such as liquid leakage, which can occur when the valve is opened, are prevented.

Further, Japanese Patent Application Laid-Open No. 2017-222152 also discusses a configuration in which a positioning portion of the above-described liquid container is formed of a member separate from an outlet port forming portion to increase a degree of freedom of design of the positioning portion and the outlet port forming portion, and in which the liquid tank has depressed portions open in the same direction as that of the needle in an area radially extending from the outlet port forming portion, and the positioning portion of the liquid container has protruding portions that engage with the depressed portions in an area outside the outlet port and extending in a radial direction with the outlet port as the center. With this configuration, in a case where the depressed portions of the liquid tank and the protruding portions of the liquid container do not engage with each other, the needle is not inserted into the outlet port, and the liquid tank is not replenished with the liquid, thereby inappropriate liquid replenishment is prevented.

Further, the configuration discussed in Japanese Patent Application Laid-Open No. 2017-222152 is advantageous in reducing stocks and spaces in a manufacturing process by using a common outlet port forming member and a common valve member regardless of the type of liquid, and changing as appropriate only a positioning member that is smaller in size than the outlet port forming member, depending on the type of liquid.

### SUMMARY

According to an aspect of the present disclosure, a liquid container includes a liquid containing member including a liquid containing portion configured to contain liquid, an outlet portion including an outlet port configured to discharge therethrough the liquid contained in the liquid containing portion, and a protection portion configured to cover the outlet port of the outlet portion, and a cover member configured to be attachable to and detachable from the liquid containing member and to prevent the liquid from leaking out from the outlet portion when the cover member is attached to the liquid containing member, wherein the cover member includes a resin having a haze value based on Japanese Industrial Standards (JIS) K7136 of 14% or more and 96% or less, wherein a thickness of a top surface of the cover member is 3.0 mm or less, wherein a maximum height roughness Rz of the top surface of the cover member based on JIS B 0601 is 50 μm or less, wherein, when a back surface of the top surface of the cover member is defined as a first surface and a surface of the protection portion facing the first surface is defined as a second surface, an L* value of the second surface in Commission Internationale de l'Eclairage (CIE) L*a*b* color space is 5 or more and 35 or less, and wherein a shortest distance between the first surface and the second surface is 0.4 mm or more and 2.0 mm or less.

Further features of the present disclosure will become apparent from the following description of exemplary embodiments with reference to the attached drawings.

### BRIEF DESCRIPTION OF THE DRAWINGS

FIG. 1 is a perspective view illustrating an external appearance of a liquid discharge apparatus.

FIG. 2 a perspective view illustrating an internal configuration of the liquid discharge apparatus.

FIGS. 3A, 3B, and 3C are an enlarged perspective view, a plan view, and a sectional view, respectively, of a portion in which liquid tanks of the liquid discharge apparatus are mounted.

FIGS. 4A and 4B are perspective views each illustrating an external appearance of a liquid container.

FIGS. 5A, 5B, 5C, and 5D are a front view, a side view, a top view, and a sectional view, respectively, of the liquid container.

FIGS. 6A, 6B, and 6C are diagrams illustrating details of a cover of the liquid container.

FIGS. 7A and 7B are a perspective view and a sectional view, respectively, illustrating a state where the liquid tank is replenished with liquid from the liquid container.

FIGS. 8A and 8B are sectional views illustrating the liquid container in a state where a cap is fastened thereto.

### DESCRIPTION OF THE EMBODIMENTS

Normally, for a liquid discharge apparatus, since a plurality of colors of ink is used, it is possible to contribute to increasing user's convenience by making ink containers respectively attachable to corresponding color ink tanks. On that point, with conventional liquid containers such as the liquid container discussed in Japanese Patent Application Laid-Open No. 2017-222152, it is difficult to visually recognize a member inside the liquid container from a top surface side of the liquid container in a state where a cover member is fastened thereto.

Further, in a manufacturing process of the liquid container, it is desirable to be able to detect the shape of a protection member using image processing through the cover member in a state where the cover member is fastened to the liquid container.

The present disclosure is directed to a liquid container and a liquid replenishment system capable of visually recognizing a difference between liquid containers easily, and improving user's convenience.

Hereinbelow, with reference to the attached drawings, exemplary embodiments will be described. The same components are described with the same reference numerals assigned. Further, relative arrangements and shapes of components described in the exemplary embodiments are merely examples.

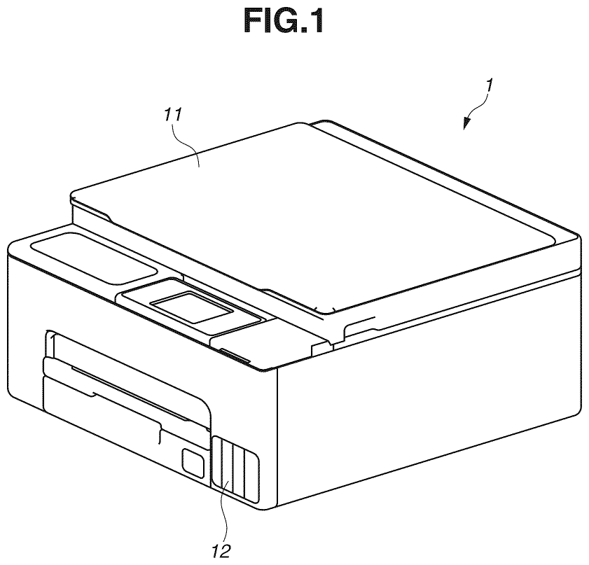

FIG. 1 is a perspective view illustrating an external appearance of a liquid discharge apparatus 1 according to an exemplary embodiment. The liquid discharge apparatus 1 illustrated in FIG. 1 is a serial-type ink jet recording apparatus. The liquid discharge apparatus 1 illustrated in FIG. 1 includes a housing 11 having a rectangular parallelepiped shape with the right-and-left direction as a longitudinal direction, and liquid tanks 12 arranged inside the housing 11. Each of the liquid tanks 12 contains ink that is a liquid to be discharged to a recording medium (not illustrated).

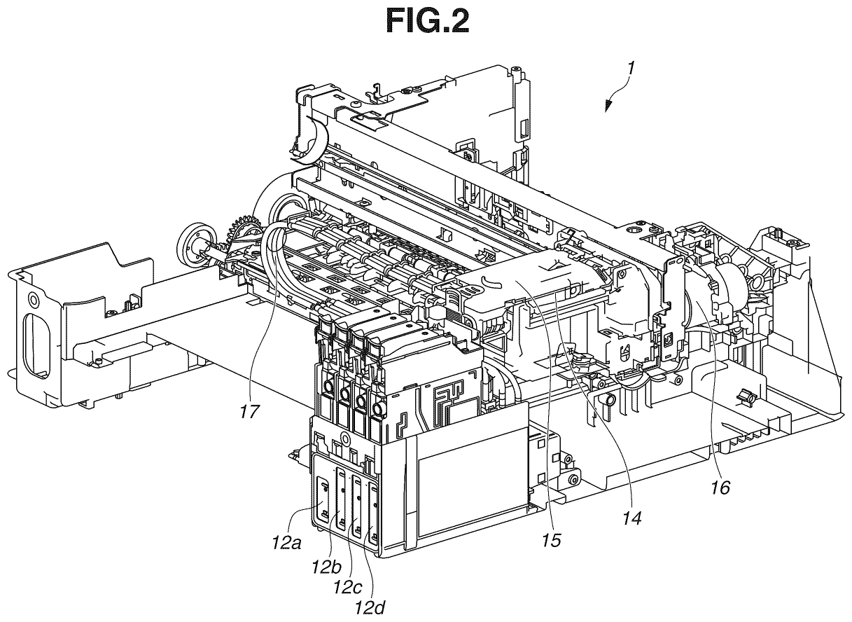

FIG. 2 is a perspective view illustrating an internal configuration of the liquid discharge apparatus 1 illustrated in FIG. 1. In FIG. 2, the liquid discharge apparatus 1 includes conveyance rollers (not illustrated) for conveying a recording medium (not illustrated), a carriage 15 with a recording head 14 arranged on a lower side thereof to discharge the liquid, and a carriage motor 16 for driving the carriage 15. The carriage 15 can be moved reciprocally in right and left directions by the carriage motor 16. The recording medium is not limited as long as an image can be formed thereon with the ink discharged from the recording head 14. For example, as the recording medium, paper, cloth, a label side of an optical disk, a plastic sheet, or an overhead projector (OHP) sheet can be used.

An ink is contained in each of the liquid tanks 12, and supplied to the recording head 14 via a liquid flow path 17 to be discharged from the recording head 14. In the present exemplary embodiment, inks of four colors (e.g., cyan, magenta, yellow, and black) are used, and as the liquid tanks 12, four liquid tanks 12a to 12d respectively containing the inks of different colors are arranged. Hereinbelow, in a case where an individual liquid tank is to be described in a distinguished manner, an alphabet is added at the end of a reference numeral for the liquid tank, such as the liquid tanks 12a, 12b, 12c, and 12d. In a case where a description is given of any liquid tank, the liquid tank is referred to as the liquid tank 12. The liquid tanks 12a to 12d (or liquid tanks 12) for different colors are arranged at a front portion of the liquid discharge apparatus 1 inside the housing 11.

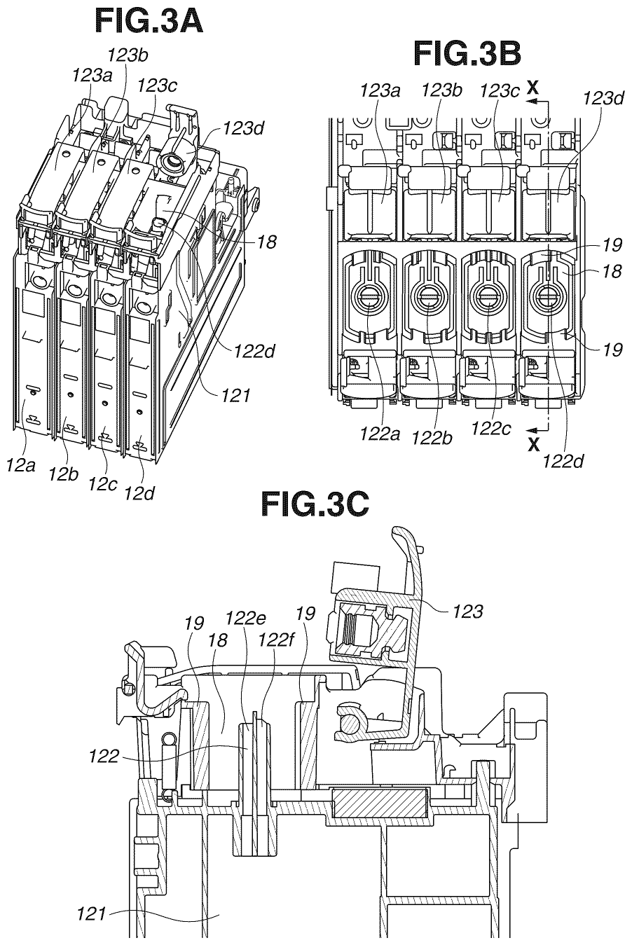

FIG. 3A is an example of an enlarged perspective view of a portion in which the liquid tanks 12a to 12d of the liquid discharge apparatus 1 illustrated in FIG. 1 are mounted. FIG. 3B is a plan view of the portion illustrated in the enlarged perspective view of FIG. 3A. Further, FIG. 3C is an X-X sectional view of the portion in FIG. 3B. Each of the liquid tanks 12 (i.e., liquid tank 12) includes a liquid tank body 121 for containing liquid, and a communication flow path 122 communicating with a liquid chamber in the liquid tank body 121. Further, the liquid tank 12 includes a tank cover 123 attachable thereto to cover the communication flow path 122 when the liquid tank 12 is not being replenished and to seal the liquid chamber of the liquid tank body 121.

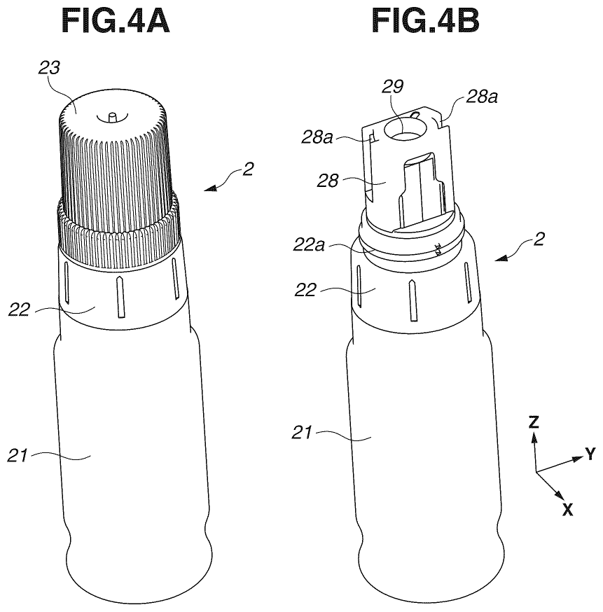

FIG. 3A illustrates a state where only a tank cover 123d for the liquid tank 12d is open. In a case where the liquid tank 12 is replenished with liquid, an outlet port of a liquid container 2 (refer to FIGS. 4A and 4B) is inserted into the communication flow path 122 to inject the liquid. Evaporation of the liquid in the liquid tank 12 can be suppressed by sealing the liquid chamber with the tank cover 123 when the liquid tank 12 is not being replenished. The communication flow path 122 includes two flow paths 122e and 122f extending in parallel in a vertical direction, and the liquid in the liquid container 2 is injected into the liquid tank 12 due to gas-liquid exchange. In the liquid discharge apparatus 1, a socket 18 is arranged at a portion where the outlet port of the liquid container 2 is inserted. In the socket 18, protruding portions 19 protruding inward from an inner peripheral wall thereof are arranged. The socket 18 is arranged for each of the liquid tanks 12a to 12d, and shapes of the protruding portions 19 are different between respective sockets 18 of the liquid tanks 12a to 12d to prevent an erroneous insertion of the liquid container 2. The protruding portions 19 are located at positions of 180 degrees rotational symmetry with respect to the central axis of the communication flow path 122.

FIGS. 4A and 4B are perspective views each illustrating an external appearance of the liquid container 2 that is a liquid container used for replenishing the liquid tank 12 with liquid. The liquid container 2 in FIG. 4A includes a bottle 21 that is a liquid containing member (main body unit) for containing the liquid, a nozzle 22 (outlet portion) connected with the bottle 21, and a cap 23 (cover member) attachable to and detachable from the nozzle 22. The cap 23 is a cover member for shielding the inside of the liquid container 2 (more specifically, bottle 21) from external air by being attached to the nozzle 22. The nozzle 22 is an outlet portion having a function as an outlet when the liquid contained in the bottle 21 is discharged to the liquid tank 12.

FIG. 4B is a perspective view illustrating an external appearance of the liquid container 2 in a state where the cap 23 is removed from the liquid container 2. An outlet port 29 formed in the nozzle 22 is opened by removing the cap 23, and a cover 28 is joined to the nozzle 22 to cover the outlet port 29. A male screw portion 22a is formed on an outer peripheral surface of the nozzle 22, and the cap 23 is joined to the outlet port 29 by screwing together the nozzle 22 and the cap 23 using the male screw portion 22a of the nozzle 22 and a female screw portion (not illustrated) formed on an inner peripheral surface of the cap 23, to seal up an area around the outlet port 29. The cover 28 includes depressed portions 28a having corresponding shapes to the protruding portions 19 of the socket 18 in the liquid discharge apparatus 1, and the shapes of the depressed portions 28a are different depending on the types of ink, as with the socket 18.

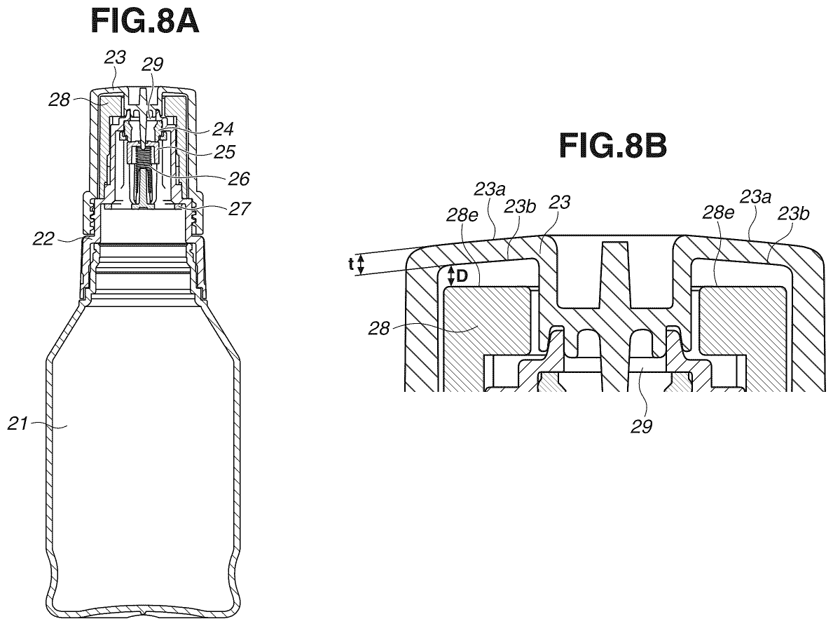

FIG. 8A is an example of a vertical sectional view of the plan view of the liquid container 2 in a state where the cap 23 is fastened thereto, viewed from an X direction. FIG. 8B is an enlarged view of an upper portion of FIG. 8A. A top surface of the cap (cover member) 23 indicates an upper surface 23a, and a back surface (first surface) of the top surface indicates a back surface 23b of the cap 23. In addition, a second surface of the cover 28 facing the first surface indicates an upper surface 28e of the cover 28 (protection portion 28).

A thickness t of the top surface of the cap 23 is a distance between the upper surface 23a and the back surface 23b of the cap 23. It is desirable that the thickness t of the top surface be 1.5 mm or more and 2.5 mm or less. In addition, in the present exemplary embodiment, a shortest distance D between the back surface 23b of the cap 23 and the upper surface 28e of the cover 28 indicates a distance between a fringe portion of the back surface 23b of the cap 23 and the upper surface 28e of the cover 28.

In this configuration, the shapes of the depressed portions 28a of the cover 28 can be visually recognized from the top surface side in a state where the cap 23 is joined to the outlet port 29 by limiting ranges of a haze value, the thickness t, and a maximum height roughness Rz of the top surface of the cap 23, a luminosity L* value of the upper surface 28e of the cover 28, and the distance D between the upper surface 28e of the cover 28 and the back surface 23b of the cap 23. More specifically, the cap 23 (cover member) includes a resin with the haze value of 14% or more and 96% or less, the thickness t of the top surface of the cap 23 is 3.0 mm or less, the maximum height roughness Rz of the top surface of the cap 23 is 50 μm or less, the luminosity L″ value of the second surface of the cover 28 (protection portion 28) is 5 or more and 35 or less, and the shortest distance D between the first surface and the second surface is 0.4 mm or more and 2.0 mm or less.

In the present disclosure, the luminosity L* value is an L* value in Commission Internationale de l'Eclairage (CIE) L*a*b* color space, and as the luminosity L* value is larger, it means the luminosity is higher. In the present exemplary embodiment of the present disclosure, the luminosity L* value of the second surface of the cover 28 is 5 or more and 35 or less, and it means that the luminosity is low and the color of the second surface is visually recognized as gray or black.

Further, in the present disclosure, the maximum height roughness Rz is based on Japanese Industrial Standards (JIS) B 0601 revised in 2013. As a value of Rz is larger, it means the surface is rougher. In the present exemplary embodiment of the present disclosure, the maximum height roughness Rz of the top surface of the cap 23 is 50 μm or less, which is a value determined so that various kinds of processing methods, such as grinding processing and shaving processing, are not hindered and the range of the maximum height roughness Rz that can be taken in emboss processing of surface processing is not included as much as possible.

In addition, in the present disclosure, the haze value is based on JIS K7136. As the haze value is closer to 100%, the degree of transparency becomes higher. In the present exemplary embodiment of the present disclosure, the cap 23 includes a resin with the haze value of 14% or more and 96% or less, which means the cap 23 includes a semi-transparent or transparent resin. The value specifies the range of the haze value measured for a member having a high degree of transparency among polypropylene (PP) members usable for spin welding of the cap 23 and the nozzle 22. In the present exemplary embodiment of the present disclosure, the thickness t and the maximum height roughness Rz of the top surface of the cap 23 is further prescribed because the degree of transparency of the cap 23 as a member is largely affected by the thickness t and the maximum height roughness Rz of the top surface in addition to the haze value of the resin that is a material. Particularly, in a case where the resin itself is semi-transparent, as the thickness t of the top surface is thinner and the maximum height roughness Rz is smaller (i.e., smoother), the degree of transparency of the cap 23 as a member becomes higher. Thus, the numerical ranges of the thickness t of the top surface of the cap 23 and the maximum height roughness Rz of the top surface prescribed in the present exemplary embodiment of the present disclosure serve as conditions for achieving a range in which, when a resin having a specific haze value is used, the degree of transparency of the cap 23 as a member becomes a level at which the color of the cover 28 can be visually recognized when the cap 23 is attached.

When the conditions described above are satisfied all together, it is possible to identify the difference in the shapes of the depressed portions 28a through image recognition by capturing an image of the top surface of the cap 23 in the state where the cap 23 is joined to the outlet port 29 and performing binarization processing that converts the captured image into two colors of white and black. In this way, it is possible to detect a mis-manufactured component and prevent the mis-manufactured component from leaking to the market by reading, in a process after the cap 23 is fastened, information about the injected ink from a data matrix engraved on the nozzle 22 based on the type of ink injected into the liquid container 2, and comparing the read information with shape information about the depressed portions 28a. With the present exemplary embodiment, the top surface of the cap 23 becomes transparent or semi-transparent to such a degree that the color of the cover 28 can be visually recognized from the top surface side (Z direction) of the cap 23 in the state where the cap 23 is attached.

In the present exemplary embodiment of the present disclosure, it is desirable that the haze value of the resin used for the cap 23 be 85% or more and 96% or less because, as the degree of transparency of the resin is higher, the degree of transparency of the cap 23 as a member tends to become higher. Further, it is desirable that the thickness of the top surface of the cap 23 be 1.5 mm or more and 2.5 mm or less because the strength of the cap 23 can be increased by the thickness being 1.5 mm or more. Further, the degree of transparency of the cap 23 as a member tends to increase by making the thickness thinner to 2.5 mm or less. Further, it is desirable that the maximum height roughness Rz of the first surface (back surface of the top surface) of the cap 23 based on JIS B 0601 be 50 μm or less. As described above, first, a smoother top surface largely contributes to a higher degree of transparency of the cap 23 when the cap 23 is visually recognized from the top surface side (Z direction) of the cap 23, but it is more desirable that the back surface of the top surface be also smooth.

There are various methods for connecting the bottle 21 and the nozzle 22, such as a method of inserting a flexible member therebetween and sealing them and a method of forming the bottle 21 and the nozzle 22 with resin and welding the two components together. The bottle 21 and the nozzle 22 may be integrally formed.

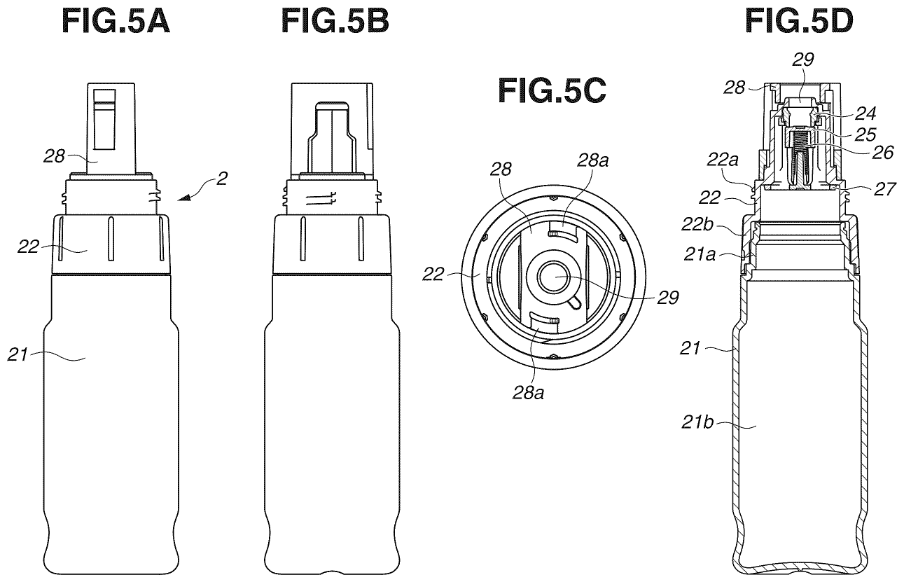

FIG. 5A is a plan view illustrating the liquid container 2 in a state where the cap 23 is removed illustrated in FIG. 4B viewed from a Y direction, FIG. 5B is a plan view of the liquid container 2 viewed from an X direction, and FIG. 5C is a top view of the liquid container 2 viewed from a Z direction. Further, FIG. 5D is a vertical sectional view of the liquid container 2 illustrated in FIG. 5B. The nozzle 22 joined to the bottle 21 includes the outlet port 29 at a leading end thereof, and the cover 28 is joined to the nozzle 22 so as to cover an entire circumference of the outlet port 29. More specifically, the outlet port 29 and the cover 28 (protection portion 28) are formed separately and joined together over the entire circumference thereof by welding. Alternatively, the outlet port 29 and the cover 28 integrally formed are also included in the scope of the present disclosure.

After an ink replenishment operation is performed on the liquid discharge apparatus 1, ink may sometimes adhere to the inside or periphery of the outlet port 29. When the ink adheres to the vicinity of the outlet port 29, the ink can adhere to a user's finger or make a desk or the like dirty in a case where the user accidentally tips over the liquid container 2 at a time of closing the cap 23 or before closing the cap 23. However, with the present configuration, since the outlet port 29 is covered with the cover 28, it is possible to prevent a user from unintentionally touching the outlet port 29 and also prevent scattering of the ink.

The cover 28 has a shape radially extending with the outlet port 29 as a center, and includes, on an extended portion, the depressed portions 28a corresponding to the shapes of the protruding portions 19 of the socket 18 of the liquid discharge apparatus 1. Thus, similar to the socket 18, the shape of the cover 28 is different depending on the type of ink. The shapes of the depressed portions 28a are point-symmetrically configured with the outlet port 29 as a center, and the liquid container 2 can be attached to the liquid discharge apparatus 1 even in a state where the liquid container 2 is rotated 180 degrees. In this case, by changing the shapes of the depressed portions 28a of the cover 28 based on the type of liquid contained in the liquid container 2, it is possible to visually recognize which type of liquid is contained in the liquid container 2. Further, by making the shapes of receiving-side members of the liquid discharge apparatus 1, into which the liquid container 2 is inserted, match the shapes of the depressed portions 28a, it is possible to use the shapes as a mechanical identifier (ID) to prevent erroneous insertion of the liquid container 2 by the user. More specifically, in a case where the liquid contained in the liquid container 2 is ink, there is a method of changing the shapes of the depressed portions 28a of the cover 28, which serve as the mechanical ID of the liquid container 2, depending on colors of the ink, such as cyan, magenta, yellow, and black.

The bottle 21 of the liquid container 2 includes a bottle welding portion 21a formed on an upper side thereof, and a liquid containing portion 21b formed on a lower side thereof. The nozzle 22 includes the outlet port 29 for discharging liquid, the male screw portion 22a having a male screw structure formed on an outer surface thereof, and a nozzle welding portion 22b with a welding surface formed on the inside or a bottom surface thereof. Examples of a material that forms the bottle 21 include polyethylene (PE) and polypropylene (PP). Examples of a material that forms the nozzle 22 include PE and PP. The nozzle 22 is joined to the bottle 21 by the nozzle welding portion 22b being welded to the bottle welding portion 21a. In a case where the bottle 21 and the nozzle 22 are joined by welding, it is desirable that the bottle 21 and the nozzle 22 be formed of materials of the same type. The nozzle 22 includes, on the inside, a seal 24 with an opening, a valve 25 for opening and closing the opening of the seal 24, a spring 26 for urging the valve 25, and a holder 27 for fixing the spring 26. Since the seal 24 prevents the liquid in the liquid containing portion 21b from leaking out in conjunction with the nozzle 22 and the valve 25, it is desirable that the seal 24 be formed using a material having flexibility, such as a rubber material and an elastomer material.

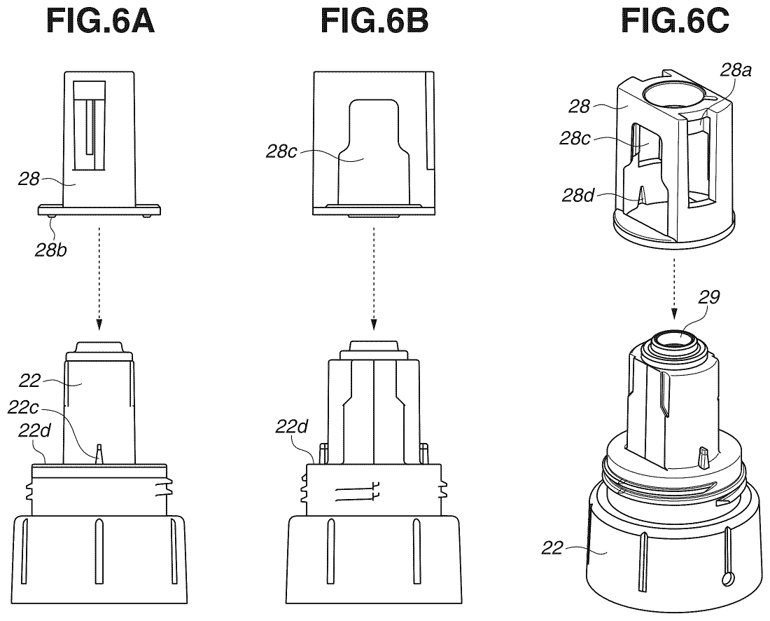

FIG. 6A is a front view illustrating a state before the cover 28 is joined to the nozzle 22 viewed from an X direction, FIG. 6B is a plan view of the state viewed from a Y direction, and FIG. 6C is a perspective view of the state.

In this configuration, the cover 28 is joined to the nozzle 22 by welding a bottom portion 28b of the cover 28 to a flat portion 22d of the nozzle 22. In FIGS. 6A and 6B, the flat portion 22d is configured on the same plane around the entire circumference of the outlet port 29, and the corresponding bottom portion 28b of the cover 28 is also configured on the same plane around the entire circumference of the outlet port 29. Accordingly, in a case where a minute ink droplet adhering to the vicinity of the outlet port 29 drips off after the ink replenishment operation performed on the liquid discharge apparatus is finished, the dripped ink droplet is blocked by a joining portion of the flat portion 22d and the bottom portion 28b, and held in a space between the nozzle 22 and the cover 28. In this way, even in the case where the minute ink droplet drips off, it is possible to prevent the dripped ink droplet from leaking out. Further, since the depressed portions 28a corresponding to the shapes of the protruding portions 19 of the liquid discharge apparatus 1 are formed in the cover 28, a position shift between the outlet port 29 and the communication flow path 122 becomes large if the shift of a joining position between the cover 28 and the nozzle 22 is large. Bosses 22c are arranged to correspond to respective grooves 28d to increase positioning accuracy between the nozzle 22 and the cover 28.

A window 28c is formed in the cover 28 in the Y direction. In a case where the size of the liquid discharge apparatus 1 is to be reduced in the Y direction, since the width of the recording medium cannot be reduced, the width in the Y direction of the nozzle 22 of the liquid container 2 to be attached to the liquid discharge apparatus 1 needs to be reduced as much as possible. However, since an ink replenishment time becomes longer if the width of the communication flow path 122 is made smaller, the width in the Y direction of the nozzle 22 needs to be reduced while the width of the communication flow path 122 is secured. For this reason, the window 28c is formed in the cover 28 in the Y direction to reduce the width in the Y direction.

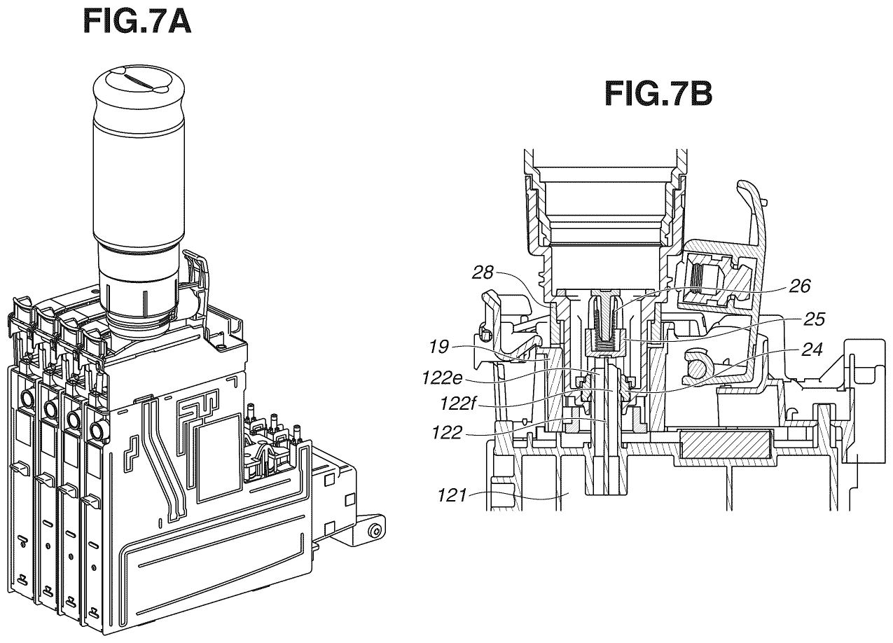

FIG. 7A is a perspective view illustrating a state as a liquid replenishment system where the liquid tank 12 of the liquid discharge apparatus 1 is replenished with liquid from the liquid container 2, and FIG. 7B is a sectional view illustrating an area around an attaching portion of the liquid container 2 and the liquid tank 12 in the above-described liquid replenishment state. When the liquid is injected from the liquid container 2 to the liquid tank 12, the liquid container 2 is attached so that the communication flow path 122 (inlet portion) of the liquid tank 12 is inserted into the outlet port 29 of the nozzle 22 of the liquid container 2. At this time, the leading end of the communication flow path 122 moves the valve 25 toward the inside of the liquid container 2, and the inside of the liquid container 2 and the liquid tank body 121 become a communication state via the communication flow path 122. The communication flow path 122 includes the two flow paths 122e and 122f, and the liquid in the liquid container 2 is injected into the liquid tank 12 due to gas-liquid exchange. More specifically, the liquid moves from the liquid container 2 to the liquid tank body 121 through one of the flow paths 122e and 122f, and gas moves from the liquid tank body 121 to the liquid container 2 through the other one of the flow paths 122e and 122f.

Disclosure of the present exemplary embodiment includes the following configurations.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-084307, filed May 23, 2023, which is hereby incorporated by reference herein in its entirety.

What is claimed is:

1. A liquid container comprising:
a liquid containing member including a liquid containing portion configured to contain liquid, an outlet portion including an outlet port configured to discharge therethrough the liquid contained in the liquid containing portion, and a protection portion configured to cover the outlet port of the outlet portion; and
a cover member configured to be attachable to and detachable from the liquid containing member and to prevent the liquid from leaking out from the outlet portion when the cover member is attached to the liquid containing member,
wherein the cover member includes a resin having a haze value based on Japanese Industrial Standards (JIS) K7136 of 14% or more and 96% or less,
wherein a thickness of a top surface of the cover member is 3.0 mm or less,
wherein a maximum height roughness Rz of the top surface of the cover member based on JIS B 0601 is 50 μm or less,
wherein, when a back surface of the top surface of the cover member is defined as a first surface and a surface of the protection portion facing the first surface is defined as a second surface, an L* value of the second surface in Commission Internationale de l'Eclairage (CIE) L*a*b* color space is 5 or more and 35 or less, and
wherein a shortest distance between the first surface and the second surface is 0.4 mm or more and 2.0 mm or less.

2. The liquid container according to claim 1, wherein a maximum height roughness Rz of the first surface of the cover member based on JIS B 0601 is 50 μm or less.

3. The liquid container according to claim 1, wherein the cover member includes a resin having the haze value based on the JIS K7136 of 85% or more and 96% or less.

4. The liquid container according to claim 1, wherein the thickness of the top surface of the cover member is 1.5 mm or more and 2.5 mm or less.

5. The liquid container according to claim 1, wherein the liquid is an ink.

6. A liquid container comprising:
a liquid containing member including a liquid containing portion configured to contain liquid, an outlet portion including an outlet port configured to discharge therethrough the liquid contained in the liquid containing portion, and a protection portion configured to cover the outlet port of the outlet portion; and
a cover member configured to be attachable to and detachable from the liquid containing member and to prevent the liquid from leaking out from the outlet portion when the cover member is attached to the liquid containing member,
wherein a color of a surface of the protection portion facing a back surface of a top surface of the cover member is black or gray, and
wherein the top surface of the cover member is transparent or semi-transparent to a degree that allows the color of the surface of the protection portion to be visually recognizable from a side of the top surface of the cover member in a state where the cover member is attached to the liquid containing member.

7. A liquid container comprising:
a liquid containing portion configured to contain liquid;
an outlet portion including an outlet port configured to discharge therethrough the liquid contained in the liquid containing portion; and
a protection portion configured to cover the outlet port of the outlet portion,
wherein an L* value of the protection portion in CIE L*a*b* color space is 5 or more and 35 or less.

8. A liquid replenishment system comprising:
an image recording apparatus including a liquid discharge head, and a liquid tank configured to contain liquid to be supplied to the liquid discharge head, the liquid tank including an inlet portion configured to receive injection of the liquid from outside; and
a liquid container configured to supply the liquid to the liquid tank from the inlet portion of the liquid tank and comprising:
a liquid containing member including a liquid containing portion configured to contain liquid, an outlet portion including an outlet port configured to discharge therethrough the liquid contained in the liquid containing portion, and a protection portion configured to cover the outlet port of the outlet portion; and
a cover member configured to be attachable to and detachable from the liquid containing member and to prevent the liquid from leaking out from the outlet portion when the cover member is attached to the liquid containing member,
wherein the cover member includes a resin having a haze value based on Japanese Industrial Standards (JIS) K7136 of 14% or more and 96% or less,
wherein a thickness of a top surface of the cover member is 3.0 mm or less,
wherein a maximum height roughness Rz of the top surface of the cover member based on JIS B 0601 is 50 μm or less,
wherein, when a back surface of the top surface of the cover member is defined as a first surface and a surface of the protection portion facing the first surface is defined as a second surface, an L* value of the second surface in Commission Internationale de l'Eclairage (CIE) L′a*b*color space is 5 or more and 35 or less, and
wherein a shortest distance between the first surface and the second surface is 0.4 mm or more and 2.0 mm or less.
